(19) United States
(12) Patent Application Publication
(10) Pub. No.: US 2020/0184554 A1
(43) Pub. Date: Jun. 11, 2020

(54) CREDIT INFORMATION PROVIDING SERVER DEVICE, CREDIT INFORMATION PROVIDING METHOD, AND RECORDING MEDIUM

(71) Applicant: NEC CORPORATION, Tokyo (JP)

(72) Inventor: Hiroshi ARAI, Tokyo (JP)

(73) Assignee: NEC CORPORATION, Tokyo (JP)

(21) Appl. No.: 16/635,375

(22) PCT Filed: Jul. 23, 2018
(86) PCT No.: PCT/JP2018/027494

§ 371 Date: Jan. 30, 2020

(30) Foreign Application Priority Data
Jul. 31, 2017 (JP) 2017-148175

(51) Int. Cl. G06Q 40/02

(52) U.S. Cl. CPC G06Q 40/025

(57) ABSTRACT

A credit information providing server device includes: at least one memory configured to store instruction; and at least one processor configured to execute the instructions to: acquire, from a terminal device, procedure information including information of a procedure performed for a person who temporarily comes from abroad; generate, based on the procedure information, credit information indicating a prediction of an economic influence produced by the person who temporarily comes from abroad; and provide, based on information identifying a person who temporarily comes from abroad, the credit information of an identified person who temporarily comes from abroad.

### TECHNICAL FIELD

The present disclosure relates to a credit information providing server device, a credit information providing system, a credit information providing method, and a recording medium.

### BACKGROUND ART

A foreigner visiting Japan may receive a service such as purchase of a tax-free article, referred to as an inbound service. Several techniques related to this inbound service have been proposed. PTL 1, for example, describes a tax exemption-related document generation device for efficiently generating a tax exemption-related document when a nonresident purchases a tax-free article (tax-exempted article) at a tax-free store.

### CITATION LIST

### Patent Literature

PTL 1: Japanese Unexamined Patent Application Publication No. 2016-66261

### SUMMARY OF INVENTION

### Technical Problem

Spending for articles and services by foreigners visiting Japan brings large profits to inbound service business operators such as a tax-free store. In contrast, it can been seen that there is a case where a loss is caused to an inbound service business operator, such as a case where a foreigner visiting Japan abuses a tax exemption system and receives tax exemption for a purpose of reselling, and therefore an additional tax is imposed on a tax-free store side.

Therefore, it is desirable that a possibility of a profit and a loss, resulting from a foreigner visiting Japan, and being received by an inbound service business operator, can be presented to an attendant to the foreigner visiting Japan, such as the inbound service business operator. At that time, it is desirable to be able to present a possibility of a profit and a loss to the attendant to the foreigner visiting Japan, with higher accuracy.

An object of the present disclosure is to provide a credit information providing server device, a credit information providing system, a credit information providing method, and a recording medium being capable of solving the above-described problem.

### Solution to Problem

According to a first aspect of the present disclosure, a credit information providing server device includes:

information acquisition processing means for acquiring, from a terminal device, procedure information including information of a procedure performed for a person who temporarily comes from abroad;

credit information generation processing means for generating, based on the procedure information, credit information indicating a prediction of an economic influence produced by the person who temporarily comes from abroad; and

credit information providing processing means for providing, based on information identifying a person who temporarily comes from abroad, the credit information of an identified person who temporarily comes from abroad.

According to a second aspect of the present disclosure, a credit information providing system includes:

a credit information providing server device and a terminal device, wherein

the credit information providing server device includes:

information acquisition processing means for acquiring, from the terminal device, procedure information including information of a procedure performed for a person who temporarily comes from abroad;

credit information generation processing means for generating, based on the procedure information, credit information indicating a prediction of an economic influence produced by the person who temporarily comes from abroad; and

credit information providing processing means for providing, based on information identifying a person who temporarily comes from abroad, the credit information of an identified person who temporarily comes from abroad.

According to a third aspect of the present disclosure, a credit information providing method includes:

acquiring, from a terminal device, procedure information including information of a procedure performed for a person who temporarily comes from abroad;

generating, based on the procedure information, credit information indicating a prediction of an economic influence produced by the person who temporarily comes from abroad; and

providing, based on information identifying a person who temporarily comes from abroad, the credit information of an identified person who temporarily comes from abroad.

According to a fourth aspect of the present disclosure, a recording medium stores a program for causing a computer to:

acquire, from a terminal device, procedure information including information of a procedure performed for a person who temporarily comes from abroad;

generate, based on the procedure information, credit information indicating a prediction of an economic influence produced by the person who temporarily comes from abroad; and

provide, based on information identifying a person who temporarily comes from abroad, the credit information of an identified person who temporarily comes from abroad.

### Advantageous Effects of Invention

According to the present disclosure, a possibility of a profit and a loss, resulting from a foreigner visiting Japan, and being received by an inbound service business operator, can be presented with relatively high accuracy to an attendant to the foreigner visiting Japan.

### BRIEF DESCRIPTION OF DRAWINGS

FIG. 1 is a schematic configuration diagram illustrating a device configuration example of a credit information providing system according to an example embodiment of the present disclosure.

FIG. 2 is a schematic block diagram illustrating a function configuration of a credit information providing server device of the example embodiment.

FIG. 3 is a diagram illustrating an example of a processing procedure of the credit information providing system when attending to a foreigner visiting Japan who visits a tax-free store according to the example embodiment.

FIG. 4 is a diagram illustrating an example of a processing procedure of the credit information providing system when attending to a foreigner visiting Japan subjected to customs inspection according to the example embodiment.

FIG. 5 is a diagram illustrating an example of a minimum configuration of a credit information providing server device according to the present disclosure.

FIG. 6 is a diagram illustrating an example of a minimum configuration of a credit information providing system according to the present disclosure.

### EXAMPLE EMBODIMENT

Hereinafter, an example embodiment of the present disclosure is described, but the following example embodiment does not limit the present disclosure described in the claims. Further, not all the combinations of features described in the example embodiment are necessarily required as elements for solving the technical problem in present disclosure.

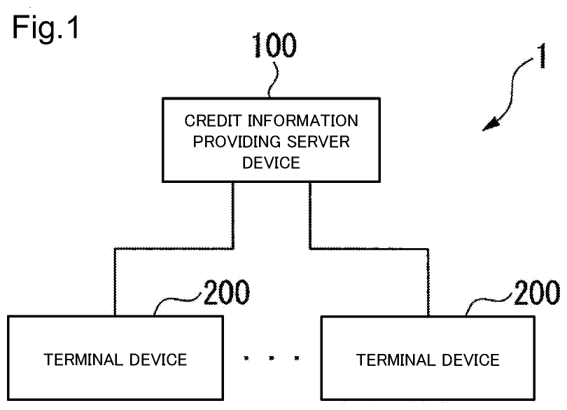

FIG. 1 is a schematic configuration diagram illustrating a device configuration example of a credit information providing system according to the example embodiment of the present disclosure. As illustrated in FIG. 1, the credit information providing system 1 includes a credit information providing server device 100 and a plurality of terminal devices 200.

The credit information providing system 1 provides information relating to a foreigner visiting Japan to an attendant to a foreigner visiting Japan, such as a clerk of a tax-free store and a customs officer. In particular, the credit information providing system 1 provides credit information of a foreigner visiting Japan. Credit information of a foreigner visiting Japan herein referred to is information indicating a possibility of bringing, by a foreigner visiting Japan, a profit or a loss to an inbound service business operator (a store or a hotel), such as information indicating that a foreigner visiting Japan is an excellent customer, or information indicating a possibility that a foreigner visiting Japan may illegally resell a tax-free article. A profit or a loss here is related to an example of an economic influence.

A foreigner visiting Japan is also referred to as a person who temporarily comes from abroad. A foreigner visiting Japan who goes through a tax exemption procedure is also referred to as a tax-exempted person.

Credit information is used for determining whether an inbound service is provided to a foreigner visiting Japan. For example, in a case of a tax-free store, credit information is used as information for determining whether a tax exemption procedure is performed for a tax-exempted person.

The credit information providing server device 100 aggregate information from each of a plurality of terminal devices 200 and generates credit information, based on the collected information. Further, the credit information providing server device 100 provides credit information in response to a request from the terminal device 200.

The credit information providing server device 100 is configured by using a computer such as a workstation.

The terminal device 200 functions as a user interface in the credit information providing system 1. In particular, the terminal device 200 displays information received from the credit information providing server device 100 and further transmits information input by a user to the credit information providing server device 100.

When an inbound service business operator being a user of a terminal device 200 attends to a foreigner visiting Japan, the terminal device 200 submits a request for credit information of the foreigner visiting Japan to the credit information providing server device 100 in response to a user operation, and displays the acquired credit information.

Further, the terminal device 200 transmits information relating to a foreigner visiting Japan to whom a user attends to the credit information providing server device 100 in response to a user operation. In particular, the terminal device 200 transmits inbound procedure information and additional information to the credit information providing server device 100.

Inbound procedure information herein referred to is information of a procedure performed for a foreigner visiting Japan. For example, in a case of a tax-free store, inbound procedure information is information of a procedure performed by an employee of a tax-free store for a tax-exempted person. Information of a procedure performed for a tax-exempted person is information to be described in a tax exemption document such as purchaser information (information identifying a foreigner visiting Japan who purchases a tax-free article) and purchase information (information indicating a purchased tax-free article and the number and price thereof). A tax exemption document herein referred to is a document prepared for a procedure in order for a foreigner visiting Japan to receive a tax exemption (tax exemption procedure). Inbound procedure information in a case of a tax exemption procedure is also referred to as tax exemption information.

Inbound procedure information may include such purchaser information and purchase information. Inbound procedure information may include, as purchaser information, passport information such as nationality and passport number. Further, inbound procedure information may include, as purchase information, information indicating a tax-free article purchased by a foreigner visiting Japan and the number and price thereof as described above.

Further, in a case of an accommodation facility such as a hotel, inbound procedure information is information described in a hotel register. Information described in a hotel register is, for example, nationality and passport number. Inbound procedure information may include such nationality and passport number.

Inbound procedure information is also referred to simply as procedure information.

Further, additional information herein referred to is information relating to a foreigner visiting Japan and is information including a content other than a content indicated by inbound procedure information. Additional information is, for example, information of a provided service and information of a reaction to a provided service. Additional information may include any one or both of information of a provided service and information of a reaction to a provided service.

For example, in a case of a tax-free store, information such as whether to be a premium member, whether a point card is used, and whether to be a reseller, is cited as an example of additional information. In a case of an accommodation facility, information such as presence or absence of a theft or breakage of equipment, presence or absence of cancellation without notice, whether to be a premium member, and presence or absence of high spending in a facility, is cited as an example of additional information. In a case of a car rental agent, information such as presence or absence of an accident, and presence or absence of breakage of equipment, is cited as an example of additional information. In a case of customs, information such as a result of a customs inspection (presence or absence of a confiscated article and presence or absence of tax collection) is cited as an example of additional information.

Additional information may include a content other than a content indicated by inbound procedure information, and a part of additional information may be the same content as a part or the whole of inbound procedure information.

Additional information may include information selected from among previously determined answer options with respect to questions of previously determined items.

After, for example, attendance to a foreigner visiting Japan is terminated, the terminal device 200 may display an input screen by business type in response to a user operation. The terminal device 200 may display an input screen by executing an application program or may display a web page of the credit information providing server device 100 formed as an input screen. The terminal device 200 may receive a user operation (e.g., a mouse click or a touch operation) for selecting any one of answer options displayed on an input screen and thereby receive input of additional information.

Inbound procedure information and additional information may include the same information as information for identifying a foreigner visiting Japan being a target of information such that both inbound procedure information and additional information include a passport number. Thereby, the credit information providing system 1 easily makes association between inbound procedure information and additional information of the same person.

Both inbound procedure information and additional information include a passport number and the credit information providing server device 100 may classify inbound procedure information and additional information for each passport number. The credit information providing server device 100 may generate and update credit information for each foreigner visiting Japan to be identified by a passport number, based on inbound procedure information and additional information classified for each passport number.

The terminal device 200 may include a document preparation function for providing an inbound service and generate inbound procedure information, based on information input in order to prepare a document. Alternatively, a user may refer to a document for providing an inbound service and input information to the terminal device 200. Alternatively, the terminal device 200 may scan a document for providing an inbound service, extract information, and automatically generate inbound procedure information.

A document for providing an inbound service herein referred to is a document prepared in order to provide an inbound service. A tax exemption document corresponds to an example of a document for providing an inbound service.

As the terminal device 200, various information devices are usable. The terminal device 200 may be configured, for example, by using a notebook personal computer, a laptop personal computer, a tablet terminal device, or a smartphone.

A terminal device 200 for referring to credit information and a terminal device 200 for transmitting information relating to a foreigner visiting Japan may be configured as one terminal device 200 or may be configured as separate terminal devices 200. Further, a terminal device 200 for transmitting inbound procedure information among pieces of information relating to a foreigner visiting Japan and a terminal device 200 for transmitting additional information may be configured as one terminal device 200 or may be configured as separate terminal devices 200.

A form of communication between the credit information providing server device 100 and the terminal device 200 is not limited to a specific form. The credit information providing server device 100 and the terminal device 200, for example, may be communicably connected in a wired manner or may be communicably connected in a wireless manner. Further, the credit information providing server device 100 and the terminal device 200 may communicate via a communication network such as the Internet.

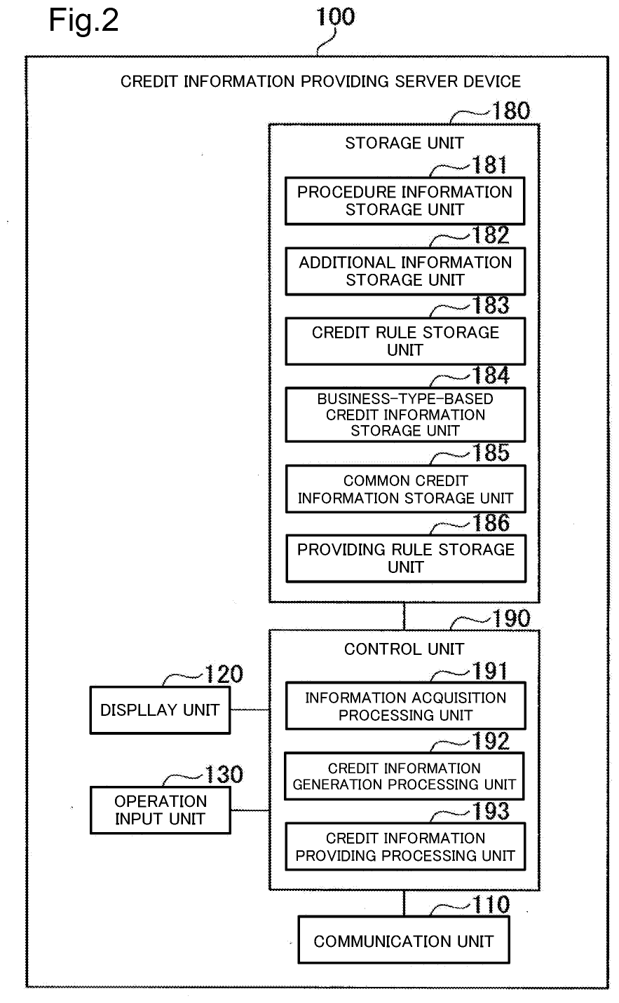

FIG. 2 is a schematic block diagram illustrating a function configuration of the credit information providing server device 100. As illustrated in FIG. 2, the credit information providing server device 100 includes a communication unit 110, a display unit 120, an operation input unit 130, a storage unit 180, and a control unit 190. The storage unit 180 includes a procedure information storage unit 181, an additional information storage unit 182, a credit rule storage unit 183, a business-type-based credit information storage unit 184, a common credit information storage unit 185, and a providing rule storage unit 186. The control unit 190 includes an information acquisition processing unit 191, a credit information generation processing unit 192, and credit information providing processing unit 193.

The communication unit 110 communicates with another device. In particular, the communication unit 110 communicates with each of terminal devices 200.

The display unit 120 includes a display screen such as a liquid crystal panel or a light emitting diode (LED) panel, and displays various images. The operation input unit 130 includes an input device such as a keyboard and a mouse, and receives a user operation.

The display unit 120 and the operation input unit 130 are used as a user interface, for example, for modifying, adding, and deleting information such as credit information and a credit rule stored in the credit information providing server device 100. Further, the display unit 120 and the operation input unit 130 are used as a user interface for executing a working operation such as shutdown of the credit information providing server device 100 and maintaining the credit information providing server device 100.

However, the display unit 120 and the operation input unit 130 are not necessarily required for a main body of the credit information providing server device 100. The credit information providing server device 100 may be configured by including, for example, a terminal device for executing an operation for the credit information providing server device 100 itself. In this case, a main body of the credit information providing server device 100 may not necessarily include the display unit 120 and the operation input unit 130.

The storage unit 180 stores various types of information. The storage unit 180 is configured by using a storage device included in the credit information providing server device 100.

The procedure information storage unit 181 stores inbound procedure information.

The additional information storage unit 182 stores additional information.

The credit rule storage unit 183 stores a credit rule. A credit rule herein referred to is a rule for generating credit information from any one or both of inbound procedure information and additional information.

As described above, credit information of a foreigner visiting Japan is information indicating a possibility of bringing a profit or a loss to an inbound service business operator by a foreigner visiting Japan. Credit information may be, for example, information indicating either “excellence” or “caution required”.

The credit rule storage unit 183 stores a business-type-based credit rule being a credit rule for generating credit information by business type and a common credit rule being a credit rule for generating credit information common to business types.

For example, in a case of a tax-free store, as an example of a credit rule for generating credit information by business type, a rule that credit information is to be “caution required” can be cited when the same person purchases tax-free articles in a plurality of tax-free stores at a predetermined number of times (a number of times in which it is difficult to consider purchases for use in an individual range of a purchaser) or more in a short period. In this case, a foreigner visiting Japan may be an illegal reseller, and therefore credit information is set to be “caution required”. Credit information in this case may be information indicating a specific precaution such as “may be a reseller”.

As an example of a credit rule for generating credit information common to business types, a rule that credit information is to be “excellence” can be cited when a total spending amount tends to be large as a whole regardless of tax-free article purchasing and lodging and a frequency of visiting Japan is high. A determination criterion of “a total spending amount tends to be large” herein referred to may be, for example, a predetermined amount or more in a total spending amount or a predetermined amount or more in a total spending amount per single visit to Japan. A determination criterion of “a frequency of visiting Japan is high” herein referred to may be, for example, a predetermined number of times or more in the number of aggregated visits to Japan or a predetermined number of times or more in the number of visits to Japan in a latest predetermined period.

A credit rule stored in the credit rule storage unit 183 may be modified, added, and deleted. For example, a manager of the credit information providing server device 100 may periodically confirm a credit rule stored in the credit rule storage unit 183 and modify, add, and delete the confirmed credit rule, as necessary.

Alternatively, a person other than a manager of the credit information providing server device 100 or a device may modify, add, and delete a credit rule. For example, a device or system being external when viewed from the credit information providing server system 1 may modify, add, and delete a credit rule. In this case, based on information such as reminder information from a police department from a device other than the terminal device 200, an external device or system may generate a new credit rule automatically or in response to a user operation. An external device or system may add the generated credit rule to a credit rule stored in the credit rule storage unit 183 or replace a credit rule stored in the credit rule storage unit 183 with the generated credit rule.

The business-type-based credit information storage unit 184 stores credit information by business type (credit information generated by using a business-type-based credit rule). Credit information by business type is also referred to as business-type-based credit information.

Business-type-based credit information stored in the business-type-based credit information storage unit 184 may be modified, added, and deleted. For example, a manager of the credit information providing server device 100 may confirm business-type-based credit information stored in the business-type-based credit information storage unit 184 periodically or when business-type-based credit information is newly registered, and modify, add, and delete the confirmed business-type-based credit information, as necessary.

Alternatively, a person other than a manager of the credit information providing server device 100 or a device may modify, add, and delete business-type-based credit information. For example, a device or system being external when viewed from the credit information providing server system 1 may modify, add, and delete business-type-based credit information. In this case, based on information such as reminder information from a police department from a device other than the terminal device 200, an external device or system may generate new business-type-based credit information automatically or in response to a user operation. An external device or system may add the generated business-type-based credit information to business-type-based credit information stored in the business-type-based credit information storage unit 184 or replace business-type-based credit information stored in the business-type-based credit information storage unit 184 with the generated business-type-based credit information.

The common credit information storage unit 185 stores credit information common to business types (credit information generated by using a common credit rule). Credit information common to business types is also referred to as common credit information.

Common credit information stored in the common credit information storage unit 185 may be modified, added, and deleted. For example, a manager of the credit information providing server device 100 may confirm common credit information stored in the common credit information storage unit 185 periodically or when common credit information is newly registered, and modify, add, and delete the confirmed common credit information, as necessary.

Alternatively, a person other than a manager of the credit information providing server device 100 or a device may modify, add, and delete common credit information. For example, a device or system being external when viewed from the credit information providing server system 1 may modify, add, and delete common credit information. In this case, based on information such as reminder information from a police department from a device other than the terminal device 200, an external device or system may generate new common credit information automatically or in response to a user operation. An external device or system may add the generated common credit information to common credit information stored in the common credit information storage unit 185 or replace common credit information stored in the common credit information storage unit 185 with the generated common credit information.

The providing rule storage unit 186 stores a providing rule. A providing rule herein referred to is a rule for selecting business-type-based credit information to be provided, in response to a request source of credit information.

When a request source of credit information is, for example, a tax-free store, business-type-based credit information relating to a tax exemption procedure is selected according to a providing rule stored in the providing rule storage unit 186. When a request source of credit information is a hotel, business-type-based credit information relating to a lodging procedure is selected according to a providing rule stored in the providing rule storage unit 186.

A providing rule stored in the providing rule storage unit 186 may be modified, added, and deleted. For example, a manager of the credit information providing server device 100 may periodically confirm a providing rule stored in the providing rule storage unit 186, and modify, add, and delete the confirmed providing rule, as necessary.

Further, a providing rule stored in the providing rule storage unit 186 may be modified, added, and deleted based on a declaration of a user. It may be possible that, for example, a user self-declares a business type or a specific business content and a manager of the credit information providing server device 100 modifies, adds, and deletes a providing rule, based on the self-declaration of the user.

The control unit 190 controls units of the credit information providing server device 100 and executes various types of processing. The control unit 190 is configured by reading a program from the storage unit 180 and executes the read program, for example, by using a central processing unit (CPU) included in the credit information providing server device 100.

The information acquisition processing unit 191 acquires information relating to a foreigner visiting Japan from the terminal device 200.

Specifically, the information acquisition processing unit 191 acquires inbound procedure information and additional information. The information acquisition processing unit 191 extracts these pieces of information from data received by the communication unit 110 from the terminal device 200.

For example, a terminal device 200 in a tax-free store transmits purchaser information and purchase information as inbound procedure information as described above, and the information acquisition processing unit 191 extracts these pieces of information. Purchaser information and purchase information correspond to an example of information indicating a tax-free article purchase situation of a foreigner visiting Japan.

The credit information generation processing unit 192 generates credit information of a foreigner visiting Japan, based on information acquired by the information acquisition processing unit 191. Specifically, the credit information generation processing unit 192 applies any one or both of inbound procedure information and additional information acquired by the information acquisition processing unit 191 from the terminal device 200 to a business-type-based credit rule and generates business-type-based credit information. Further, the credit information generation processing unit 192 applies any one or both of inbound procedure information and additional information acquired by the information acquisition processing unit 191 from the terminal device 200 to a common credit rule and generates common credit information.

The credit information generation processing unit 192 causes the business-type-based credit information storage unit 184 to store the generated business-type-based credit information in. Further, the credit information generation processing unit 192 causes the common credit information storage unit 185 to store the generated common credit information in.

The credit information generation processing unit 192 generates, for example, based on information from a terminal device 200 of a tax-free store, credit information according to a possibility of reselling a tax-free article by a foreigner visiting Japan.

The credit information generation processing unit 192 may generate credit information for an individual unit or may generate credit information for a group unit such as a family lodging in the same room, or a group having the same nationality and age.

The credit information providing processing unit 193 provides credit information of an identified foreigner visiting Japan according to information identifying a foreigner visiting Japan. Specifically, the credit information providing processing unit 193 retrieves, for an inquiry of credit information from the terminal device 200, business-type-based credit information according to a business type of an inquiry source among pieces of business-type-based credit information of a foreigner visiting Japan of an inquiry target from the business-type-based credit information storage unit 184, and controls the communication unit 110 to transmit the retrieved business-type-based credit information to a terminal device 200 of an inquiry source. Further, the credit information providing processing unit 193 retrieves common credit information of a foreigner visiting Japan of an inquiry target from the common credit information storage unit 185, and controls the communication unit 110 to transmit the retrieved common credit information to a terminal device 200 of an inquiry source.

With regard to identification of business-type-based credit information according to a business type of an inquiry source, for example, the providing rule storage unit 186 stores a providing rule for selecting business-type-based credit information by business type by receiving input of identification information of a terminal device 200 of an inquiry source. The credit information providing processing unit 193 applies the identification information of the terminal device 200 of the inquiry source to a providing rule and selects business-type-based credit information according to a business type of the inquiry source.

Alternatively, it may be possible that the credit information providing processing unit 193 previously stores a correspondence table between identification information of the terminal device 200 and a business type, and a business type of an inquiry source is identified based on the correspondence table. In this case, the providing rule storage unit 186 may store a providing rule for selecting business-type-based credit information, based on a business type, and the credit information providing processing unit 193 may identify business-type-based credit information according to a business type of an inquiry source by using the providing rule. Further, with regard to identification of a foreigner visiting Japan of an inquiry target, for example, the terminal device 200 transmits an inquiry of credit information by including passport information, and the credit information providing processing unit 193 identifies a foreigner visiting Japan of an inquiry target from the passport information.

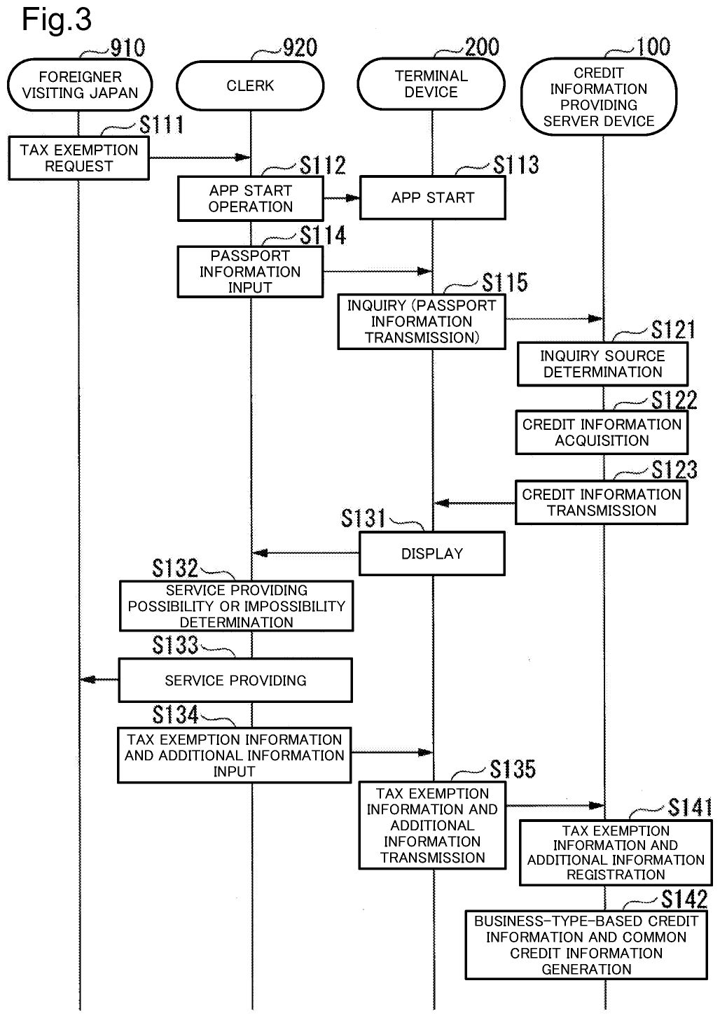

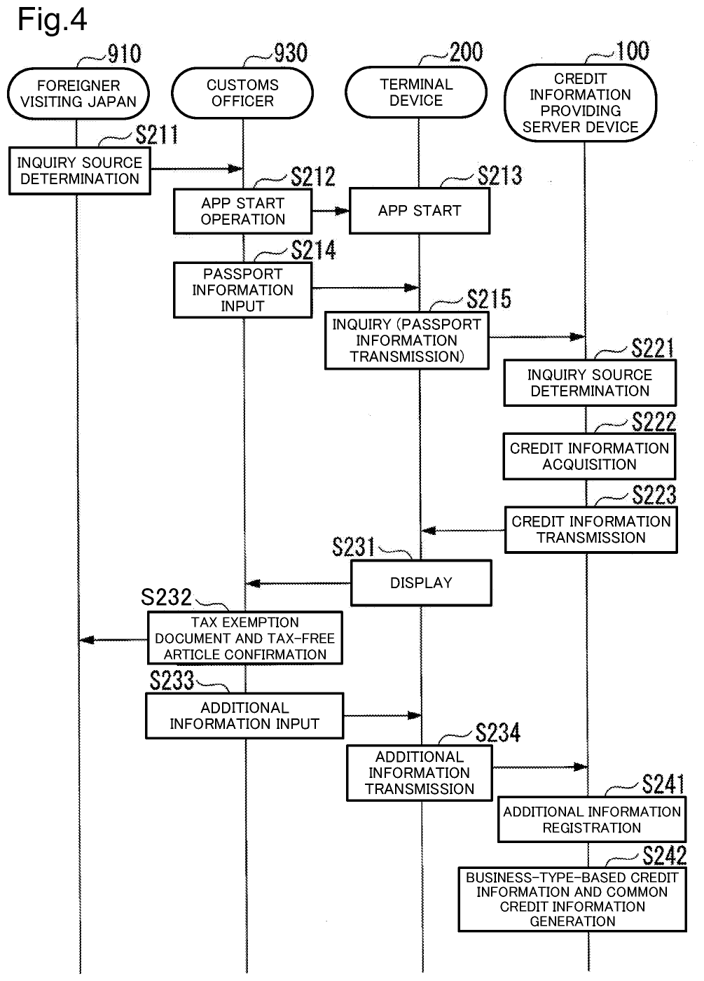

Next, with reference to FIG. 3 and FIG. 4, an operation of the credit information providing system 1 is described.

FIG. 3 is a diagram illustrating an example of a processing procedure of the credit information providing system 1 when attending to a foreigner visiting Japan who visits a tax-free store.

In the processing of FIG. 3, when a foreigner visiting Japan 910 decides a product to be purchased and asks a clerk 920 for tax exemption (sequence S111), the clerk 920 executes an operation of starting an application program for operating a terminal device 200 as a terminal device for a tax-free store (sequence S112). The terminal device 200 starts the application program in response to an operation of the clerk 920 (sequence S113).

When the terminal device 200 is used dedicatedly as a terminal device for a tax-free store, the terminal device 200 may cause an application program for a tax-free store to stay resident. In this case, processing of sequences S112 and S113 is not necessary.

Next, the clerk 920 inputs passport information of the foreigner visiting Japan 910 to the terminal device 200 (sequence S114). Passport information herein referred to is information described or stored in a passport. Passport information includes identification information identifying the foreigner visiting Japan 910.

It may be possible that, for example, the terminal device 200 includes a passport reader that reads passport information and the clerk 920 places the passport reader on a passport of the foreigner visiting Japan 910 and causes the passport reader to read the passport information.

The terminal device 200 that receives input of the passport information transmits the passport information to the credit information providing server device 100 and inquires about credit information (sequence S115).

In the credit information providing server device 100 that receives the inquiry from the terminal device 200, the credit information providing processing unit 193 determines an inquiry source (sequence S121) and retrieves business-type-based credit information and common credit information according to the determination result (sequence S122).

As described above, for example, the credit information providing processing unit 193 extracts identification information of a terminal device 200 of an inquiry source from a reception signal, applies the acquired identification information to a providing rule, and selects business-type-based credit information according to a business type of the inquiry source. Further, the credit information providing processing unit 193 narrows down business-type-based credit information of a foreigner visiting Japan identified by passport information among the pieces of acquired business-type-based credit information. Further, the credit information providing processing unit 193 retrieves common credit information of the foreigner visiting Japan identified by the passport information from the common credit information storage unit 185.

The credit information providing processing unit 193 having retrieved the credit information transmits, by controlling the communication unit 110, the acquired credit information (business-type-based credit information and common credit information) to the terminal device 200 of the inquiry source (sequence S123).

The terminal device 200 displays the credit information acquired from the credit information providing server device 100 (sequence S131).

The clerk 920 refers to the credit information displayed by the terminal device 200 and determines a possibility or impossibility of providing a service to the foreigner visiting Japan (sequence S132).

In the example of FIG. 3, the clerk 920 determines that a service can be provided and provides the service to the foreigner visiting Japan 910 (sequence S133). Specifically, the clerk 920 prepares a tax exemption document in response to a tax exemption request of the foreigner visiting Japan 910 and hands the prepared tax exemption document to the foreigner visiting Japan 910.

When in sequence S132, an impossibility of providing a service is determined, the clerk 920 does not provide a service to the foreigner visiting Japan 910 and makes a reply that it is impossible to provide a service. In contrast, when the foreigner visiting Japan 910 is determined as an excellent customer, based on credit information in sequence S132, the clerk 920 may provide, in addition to preparation of a tax exemption document, a special service such as a guide to a VIP room in order to increase a repeat rate.

The clerk 920 inputs, when completing attendance to the foreigner visiting Japan 910, tax exemption information and additional information to the terminal device 200 (sequence S134). Tax exemption information herein referred to is information such as purchaser information and purchase information described in a tax exemption document.

When in sequence S132, an impossibility of providing a service is determined, the clerk 920 inputs a fact that a tax exemption document is not provided and additional information to the terminal device 200 in sequence S134.

The terminal device 200 having received the input of the tax exemption information and the additional information transmits the input tax exemption information and additional information to the credit information providing server device 100 (sequence S135).

In the credit information providing server device 100 having received the tax exemption information and the additional information from the terminal device 200, the information acquisition processing unit 191 causes the procedure information storage unit 181 to store the tax exemption information, and causes the additional information storage unit 182 to store the additional information (sequence S141). Specifically, from reception data received by the communication unit 110 from the terminal device 200, the information acquisition processing unit 191 extracts any one or both of tax exemption information and additional information. When tax exemption information is extracted, the information acquisition processing unit 191 causes the procedure information storage unit 181 to store the extracted tax exemption information. When additional information is extracted, the information acquisition processing unit 191 causes the procedure information storage unit 181 to store the extracted additional information.

Further, the credit information generation processing unit 192 applies the tax exemption information and the additional information to a credit rule, generates business-type-based credit information and common credit information, and causes the business-type-based credit information storage unit 184 and the common credit information storage unit 185 to store the generated business-type-based credit information and common credit information(sequence S142).

Specifically, when the procedure information storage unit 181 newly stores tax exemption information in sequence S141, the credit information generation processing unit 192 retrieves the newly stored tax exemption information from the procedure information storage unit 181. Further, when the additional information storage unit 182 newly stores additional information in sequence S141, the credit information generation processing unit 192 retrieves the newly stored additional information from the additional information storage unit 182. Further, the credit information generation processing unit 192 retrieves a business-type-based credit rule and a common credit rule from the credit rule storage unit 183.

The credit information generation processing unit 192 applies any one or both of the retrieved tax exemption information and additional information to the retrieved business-type-based credit rule and generates business-type-based credit information. The credit information generation processing unit 192 causes the business-type-based credit information storage unit 184 to store the generated business-type-based credit information.

Further, the credit information generation processing unit 192 applies any one or both of the retrieved tax exemption information and additional information to the retrieved common credit rule and generates common credit information. The credit information generation processing unit 192 causes in the common credit information storage unit 185 to store the generated common credit information.

After sequence S142, the processing of FIG. 3 is terminated.

FIG. 4 is a diagram illustrating an example of a processing procedure of the credit information providing system 1 when attending to a foreigner visiting Japan subjected to customs inspection.

In processing of FIG. 4, when a foreigner visiting Japan 910 presents a purchased product to a customs officer 930 and submits a tax exemption document (sequence S211), the customs officer 930 executes an operation of starting an application program for operating a terminal device 200 as a terminal device for customs (sequence S212). The terminal device 200 starts an application program in response to an operation of the customs officer 930 (sequence S213).

When the terminal device 200 is used dedicatedly as a terminal device for customs, the terminal device 200 may cause an application program for customs to stay resident. In this case, processing of sequences S212 and S213 is not necessary.

The customs officer 930 inputs passport information of the foreigner visiting Japan 910 to the terminal device 200 (sequence S214). The terminal device 200 having received the input of the passport information transmits the passport information to the credit information providing server device 100 and inquires about credit information (sequence S215). The processing of sequences S214 and S215 is similar to the processing of sequences S114 and S115 in FIG. 3.

In the credit information providing server device 100 having received the inquiry from the terminal device 200, the credit information providing processing unit 193 determines an inquiry source (sequence S221) and retrieves business-type-based credit information and common credit information according to the determination result (sequence S222). The credit information providing processing unit 193 having retrieved the credit information controls the communication unit 110 to transmit the acquired credit information (business-type-based credit information and common credit information) to the terminal device 200 of the inquiry source (sequence S223).

The processing of sequences S221 to S223 is similar to the processing of sequence S121 to S123 in FIG. 3 except that the credit information providing processing unit 193 selects business-type-based credit information for customs instead of business-type-based credit information for a tax-free store.

The terminal device 200 displays the credit information acquired from the credit information providing server device 100 (sequence S231).

The customs officer 930 confirms a tax exemption document and a tax-free article by using the credit information displayed by the terminal device 200 as reference information of a customs inspection (sequence S232). When, for example, credit information indicates caution required, the customs officer 930 may carefully confirm a tax exemption document and a tax-free article.

The customs officer 930 inputs, after completing a customs procedure for the foreigner visiting Japan 910, additional information to the terminal device 200 (sequence S233). The terminal device 200 transmits the input additional information to the credit information providing server device 100 (sequence S234).

In the credit information providing server device 100 having received the additional information from the terminal device 200, the information acquisition processing unit 191 causes the additional information storage unit 182 to store the additional information (sequence S241).

Further, the credit information generation processing unit 192 applies the additional information to a credit rule, generates business-type-based credit information and common credit information, and causes the business-type-based credit information storage unit 184 and the common credit information storage unit 185 to store the generated business-type-based credit information and common credit information (sequence S242).

After sequence S242, the processing of FIG. 4 is terminated.

As described above, the information acquisition processing unit 191 acquires inbound procedure information from a terminal device. The credit information generation processing unit 192 generates credit information, based on the acquired information. The credit information providing processing unit 193 provides, according to information identifying a foreigner visiting Japan, credit information of an identified foreigner visiting Japan.

Thereby, the credit information providing system 1 presents, to an attendant to a foreigner visiting Japan, credit information of the foreigner visiting Japan and thereby can present a possibility of a profit and a loss.

In particular, the credit information providing system 1 can present credit information based on information acquired from a plurality of terminal devices 200 and can present with relatively high accuracy a possibility of a profit and a loss to an attendant to a foreigner visiting Japan. Even when, for example, there is no history of store entry of a foreigner visiting Japan of an inquiry target to a store of an inquiry source, the credit information providing system 1 can present credit information, based on information of the foreigner visiting Japan in another store.

Credit information may be information indicating a possibility of bringing, by a foreigner visiting Japan, a profit or a disadvantage to an inbound service business operator.

An attendant attending to a tax-exempted person can understand, by referring to the credit information, a possibility of bringing, by the tax-exempted person, a profit or a disadvantage to a store and can obtain a reference for determining whether a tax exemption procedure is performed for the tax-exempted person.

Further, inbound procedure information may include information of a tax-free article purchased by a foreigner visiting Japan being a tax-exempted person. In this case, the information acquisition processing unit 191 acquires inbound procedure information including information of a tax-free article purchased by a foreigner visiting Japan. The credit information generation processing unit 192 generates, based on the inbound procedure information, for example, credit information according to a possibility of reselling a tax-free article by the foreigner visiting Japan. Credit information may be information indicating a possibility of reselling a tax-free article by a tax-exempted person.

A clerk of a tax-free store refers to credit information of a foreigner visiting Japan during attendance, determines a possibility of reselling a tax-free article by the foreigner visiting Japan, and thereby can provide no service for tax exemption when determining that a possibility of reselling is high. Thereby, a possibility in that a store suffers damage such that a foreigner visiting Japan resells a product and an additional tax is imposed on a store or a store credit is decreased can be reduced.

Further, the information acquisition processing unit 191 acquires additional information. The credit information generation processing unit 192 generates credit information, based on inbound procedure information and additional information. The credit information generation processing unit 192 generates credit information, based on not only inbound procedure information but also additional information, and thereby the credit information generation processing unit 192 can generate credit information with higher accuracy.

The credit information generation processing unit 192 may generate credit information, based on additional information input from an attendant to a tax-exempted person.

The credit information generation processing unit 192 generates credit information, based on additional information input from an attendant actually attending to a tax-exempted person and thereby can generate credit information with higher accuracy.

A manner for inputting additional information is flexible. In other words, as a manner for inputting additional information, various input manners are usable. For example, a user may previously determine an input item according to a business type. Alternatively, a user previously determines a necessary input item and optionally input an input item other than the necessary input item. Further, a hand-written input item may be provided and an item in which an image is input may be provided.

Further, as described above, selection input as input of additional information may be possible. Therefore, additional information may include information acquired by selecting, by an attendant to a foreigner visiting Japan, an answer among answer options previously determined for questions of previously determined items. An attendant (a user of a terminal device 200) inputting additional information makes an answer to any one of answer options, based on a fact during attendance and thereby can input additional information. In this point, a load of inputting additional information by an attendant can be reduced.

Further, the credit information generation processing unit 192 generates business-type-based credit information and common credit information.

Thereby, the credit information providing system 1 can provide more various pieces of information to a user than when only business-type-based credit information is provided. In this point, a user refers to information provided by the credit information providing system 1 and thereby can more appropriately determine attendance to a foreigner visiting Japan.

In particular, even when a foreigner visiting Japan of an inquiry target has a short use history in a business type of a store of an inquiry source, the credit information providing system 1 can provide common credit information acquired for another business type to a user. When, for example, a tax-free store inquires about credit information with respect to a foreigner visiting Japan who has a large number of times of hotel use but uses a tax-free store for the first time, the credit information providing system 1 can present common credit information acquired based on hotel use of the foreigner visiting Japan to a clerk of the tax-free store.

Further, a user (a person using a terminal device 200) inputting information of a foreigner visiting Japan to a terminal device 200 may input inbound procedure information that is information of a procedure performed for a foreigner visiting Japan. A user may input, for example, a described item of a document prepared during a procedure to a terminal device 200 as inbound procedure information. A user does not need to generate new information, and therefore a load of inputting, by a user, information to a terminal device 200 is small.

Further, when the terminal device 200 functions as a device for document preparation, input information for document preparation can be used also as inbound procedure information. A user does not need to separately execute an input operation for inbound procedure information, and therefore a load on a user can be reduced.

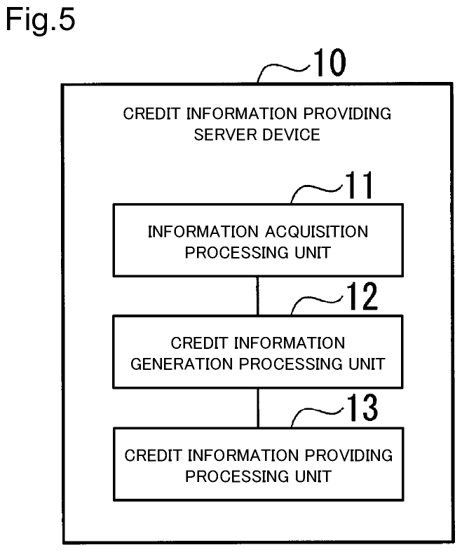

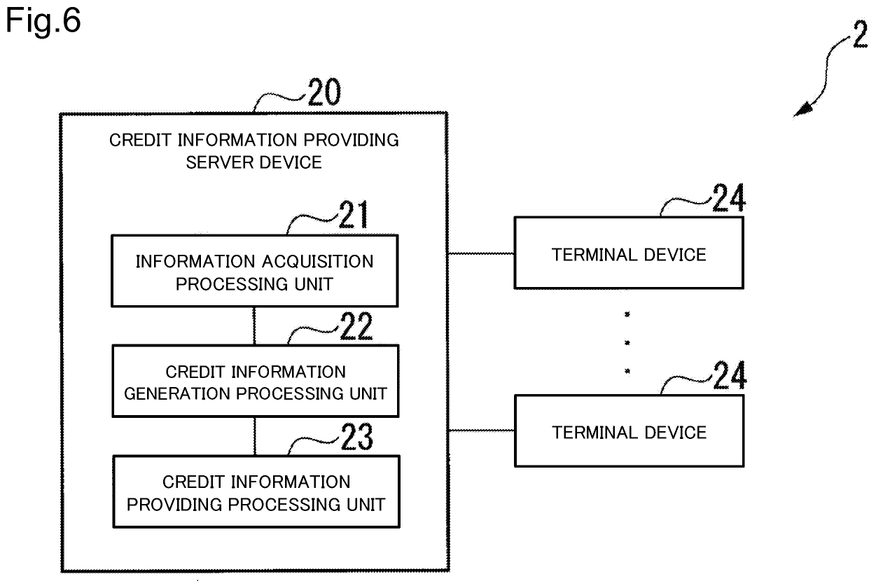

Next, with reference to FIG. 5 and FIG. 6, a minimum configuration of the present disclosure is described.

FIG. 5 is a diagram illustrating an example of a minimum configuration of a credit information providing server device according to the present disclosure. A credit information providing server device 10 illustrated in FIG. 5 includes an information acquisition processing unit 11, a credit information generation processing unit 12, and a credit information providing processing unit 13.

The information acquisition processing unit 11 in the configuration acquires, from a terminal device, procedure information that is information of a procedure performed for a person who temporarily comes from abroad. The credit information generation processing unit 12 generates, based on the procedure information, credit information indicating a prediction of an economic influence produced by the person who temporarily comes from abroad. The credit information providing processing unit 13 provides, based on information identifying a person who temporarily comes from abroad, credit information of an identified person who temporarily comes from abroad.

Thereby, the credit information providing server device 10 transmits credit information of a foreigner visiting Japan (a person who temporarily comes from abroad) to a terminal device, cause the terminal device to present the credit information of the foreigner visiting Japan to an attendant to the foreigner visiting Japan, and thereby can present a possibility of a profit and a loss to the attendant.

In particular, the credit information providing server device 10 can provide credit information based on information acquired from a plurality of terminal devices and can present a possibility of a profit and a loss to an attendant to a foreigner visiting Japan with relatively high accuracy. Even when, for example, there is no history of store entry of a foreigner visiting Japan of an inquiry target to a store of an inquiry source, the credit information providing server device 10 can provide credit information, based on information of the foreigner visiting Japan in another store.

FIG. 6 is a diagram illustrating an example of a minimum configuration of a credit information providing system according to the present disclosure. A credit information providing system 2 illustrated in FIG. 2 includes a credit information providing server device 20 and one or more terminal devices 24. The credit information providing server device 20 includes an information acquisition processing unit 21, a credit information generation processing unit 22, and a credit information providing processing unit 23.

The information acquisition processing unit 21 in the configuration acquires, from a terminal device 24, procedure information that is information of a procedure performed for a person who temporarily comes from abroad. The credit information generation processing unit 22 generates, based on the procedure information, credit information indicating a prediction of an economic influence produced by the person who temporarily comes from abroad. The credit information providing processing unit 23 provides, based on information identifying a person who temporarily comes from abroad, credit information of an identified person who temporarily comes from abroad.

Thereby, the credit information providing system 2 presents, to an attendant to a foreigner visiting Japan (a person who temporarily comes from abroad), credit information of the foreigner visiting Japan and thereby can present a possibility of a profit and a loss to the attendant.

In particular, the credit information providing system 2 can provide credit information based on information acquired from a plurality of terminal devices 24 and can present a possibility of a profit and a loss to an attendant to a foreigner visiting Japan with relatively high accuracy. Even when, for example, there is no history of store entry of a foreigner visiting Japan of an inquiry target to a store of an inquiry source, the credit information providing system 2 can provide credit information, based on information of the foreigner visiting Japan in another store.

It may be possible that a program for achieving the whole or a part of the credit information providing server device 100 is recorded on a computer readable recording medium, the program recorded on the recording medium is read into a computer system and executed, and thereby processing of units is executed. It is assumed that a “computer system” herein referred to includes an operating system (OS) and hardware such as a peripheral device.

Further, a “computer readable recording medium” is referred to as a portable medium such as a flexible disk, a magneto-optical disc, a read only memory (ROM), and a compact disk read-only memory (CD-ROM), and a storage device such as a hard disk included in a computer system. Further, the program may be for achieving a part of the above-described function or may be for achieving the above-described function in combination with a program already recorded in a computer system.

As described above, while an example embodiment of this disclosure has been described with reference to the accompanying drawings, a specific configuration is not limited to this example embodiment and a design in a scope without departing from the gist of this disclosure is included.

The present disclosure has been described as using the above-described example embodiment as an exemplary case. However, the present disclosure is not limited to the above-described example embodiment. In other words, the present disclosure can be applied with various aspects that can be understood by those of ordinary skill in the art without departing from the scope of the present disclosure.

This application is based upon and claims the benefit of priority from Japanese patent application No. 2017-148175, filed on Jul. 31, 2017, the disclosure of which is incorporated herein in its entirety by reference.

### REFERENCE SIGNS LIST

1, 2 Credit information providing system
10, 20, 100 Credit information providing server device
11, 21, 191 Information acquisition processing unit
12, 22, 192 Credit information generation processing unit
13, 23, 193 Credit information providing processing unit
24, 200 Terminal device
110 Communication unit
120 Display unit
130 Operation input unit
180 Storage unit
181 Procedure information storage unit
182 Additional information storage unit
183 Credit rule storage unit
184 Business-type-based credit information storage unit
185 Common credit information storage unit
186 Providing rule storage unit
190 Control unit

1. A credit information providing server device comprising:
at least one memory configured to store instructions; and
at least one processor configured to execute the instructions to:
acquire, from a terminal device, procedure information including information of a procedure performed for a person who temporarily comes from abroad;
generate, based on the procedure information, credit information indicating a prediction of an economic influence produced by the person who temporarily comes from abroad; and
provide, based on information identifying a person who temporarily comes from abroad, the credit information of an identified person who temporarily comes from abroad.

2. The credit information providing server device according to claim 1, wherein
the at least one processor configured to execute the instructions to generate credit information, based on the procedure information and additional information input from an attendant to the person who temporarily comes from abroad.

3. The credit information providing server device according to claim 1, wherein
the procedure information includes information of a tax-free article purchased by the person who temporarily comes from abroad.

4. The credit information providing server device according to claim 1, wherein
the at least one processor configured to execute the instructions to generate business-type-based credit information including credit information by business type and common credit information including credit information common to business types.

5. The credit information providing server device according to claim 2, wherein
at least one processor configured to execute the instructions to generate the credit information, based on the procedure information, the additional information, and a credit rule for generating the credit information from the procedure information and the additional information.

6. The credit information providing server device according to claim 2, wherein
the additional information is input based on selection performed by the attendant from among options with respect to questions of determined items.

7. The credit information providing server device according to claim 1, wherein
the credit information indicates a possibility of bringing, by the person who temporarily comes from abroad, a profit or a disadvantage to an attendant to the person who temporarily comes from abroad.

8. (canceled)

9. A credit information providing method comprising:
acquiring, from a terminal device, procedure information including information of a procedure performed for a person who temporarily comes from abroad;
generating, based on the procedure information, credit information indicating a prediction of an economic influence produced by the person who temporarily comes from abroad; and
providing, based on information identifying a person who temporarily comes from abroad, the credit information of an identified person who temporarily comes from abroad.

10. A non-transitory computer readable medium storing a program for causing a computer to:
acquire, from a terminal device, procedure information including information of a procedure performed for a person who temporarily comes from abroad;
generate, based on the procedure information, credit information indicating a prediction of an economic influence produced by the person who temporarily comes from abroad; and
provide, based on information identifying a person who temporarily comes from abroad, the credit information of an identified person who temporarily comes from abroad.
